(19) United States
(12) Patent Application Publication
(10) Pub. No.: US 2021/0008585 A1
(43) Pub. Date: Jan. 14, 2021

(54) Nozzle

(71) Applicant: United Benefit Corp., New Taipei City (TW)

(72) Inventors: Yuan Hse Chang, New Taipei City (TW); Shih Chang Chang, New Taipei City (TW)

(21) Appl. No.: 16/507,759

(22) Filed: Jul. 10, 2019

(51) Int. Cl. B05B 17/04

(52) U.S. Cl. CPC B05B 17/04

(57) ABSTRACT

A nozzle includes a body and a spoiler. The body has a fluid path, and an inlet and a spray orifice respectively located at opposite two sides of the fluid path. The spoiler is detachably disposed in the fluid path, and includes a barrier plate parallel to the inlet, wherein the barrier plate has grooves, and each groove has a through hole.

### BACKGROUND OF THE INVENTION

### 1. Field of the Invention

The present application relates to a nozzle, especially to a nozzle having a spoiler.

### 2. The Prior Arts

The nozzle is a device that atomizes or distributes fluids, and can be applied to various industrial fields, such as food, mechanical, agriculture, steel, chemistry, automobile, electronic, paper, printing, environment protection, power generation and water treatment. According to nature of the fluids, the nozzles can be divided into single-phase nozzles, two-phase nozzles and multi-phase nozzles; according to a shape of spray, the nozzles can be divided into hollow cone nozzles, full cone nozzles, rectangle nozzles, elliptical nozzles, flat jet nozzles, straight jet nozzles, etc. Although a structure of the nozzle is simple, it is necessary to utilize hydromechanics, mechanics, material sciences and other expertise accompanying with precision machining technology and strict quality control to manufacture the nozzle having a spray angle, a spray volume and a spray pressure met industrial requirements on precision and stability.

The full cone nozzle has a vane installed therein, and the vane has an X-shape, an S-shape, a spiral shape, or other shapes. FIG. 1 is a cross-sectional view schematically illustrating the full cone nozzle having an X-shape vane of current technology. As shown in FIG. 1, the full cone nozzle 1 includes a body 10 and the X-shape vane 11. The body 10 has an inlet 101, a turbulence region 102, an atomization region 103 and a spray orifice 104, wherein the atomization region 103 gradually shrinks from a cylinder to be a hemispherical space along a direction from the turbulence region 102 to the spray orifice 104, and the spray orifice 104 is formed at center of the hemispherical space. The X-shape vane 11 is installed in the turbulence region 102, and has a spiral structure 111 and a rotational staggered fluid path 112.

A fluid enters the turbulence region 102 from the inlet 101, the spiral structure 111 forces the fluid to split and rotate along the fluid path 112; the split fluid enters the atomization region 103, then is dispersed into small droplets in the gradually shrunk space; and the rotating droplets passing through the spray orifice 104 are dispersed by a centrifugal force to form a full cone-like spray.

The X-shape vane can be manufactured by lathe milling of rod material, or high temperature sintering of metal powder mixed with plastic material. The lathe milling has low efficiency, so it is rarely adopted by the industries. The high temperature sintering has a low cost, also a low precision, and produces air pollution during the sintering. Although the conventional nozzle can control the spray angle and the spray volume with the vane, the body and the vane are separated elements, and to complete the conventional nozzle further needs assembling the two elements. During manufacturing and assembling the body and the vane, the two different elements easily have different accuracies that affect performance of the nozzle, and the cost and loss are increased, so that the conventional nozzle cannot meet the various industrial requirements. Therefore, how to solve the problems of precision, assembly and cost of the conventional nozzles is a main aspect of the present application.

### SUMMARY OF THE INVENTION

To achieve the aforesaid aspect, the present application provides a nozzle including a body and a spoiler. The body has a fluid path, and an inlet and a spray orifice respectively located at opposite two sides of the fluid path. The spoiler is detachably disposed in the fluid path, and includes a barrier plate parallel to the inlet, wherein the barrier plate has grooves, and each groove has a through hole.

In an embodiment, the spoiler includes a side wall connecting to the barrier plate.

In an embodiment, a surface profile of the side wall corresponds to a shape of the fluid path.

In an embodiment, the spoiler is disposed in the fluid path in a way that the grooves face the inlet.

In an embodiment, the spoiler is disposed in the fluid path in a way that the grooves face the spray orifice.

In an embodiment, the grooves respectively extend from center of the barrier plate in different directions, and the grooves are separated from each other by an angle.

In an embodiment, the through hole is formed at a side of an extended end of each groove.

In an embodiment, the through hole is form at the center of the barrier plate.

In an embodiment, the grooves do not connect to each other.

In an embodiment, a width of each groove gradually increases from one end to the other end, and the through hole is formed at the end of the largest or smallest width of the groove.

In the nozzle according to the present application, the body has the fluid path, the inlet and the spray orifice, the spoiler disposed in the fluid path includes the barrier plate parallel to the inlet, the barrier plate has grooves, the through hole is formed at each groove, the fluid in the fluid path is split by the grooves and the through holes, then impact to form uniformly dispersed droplets, so that a spray having a specific shape and effect is produced.

### BRIEF DESCRIPTION OF THE DRAWINGS

In the accompanying drawings,

FIG. 1 is a cross-sectional view schematically illustrating the full cone nozzle having the X-shape vane of current technology;

FIG. 2 is a cross-sectional exploded view schematically illustrating the nozzle of an embodiment according to the present application;

FIG. 3A is a three-dimensional view schematically illustrating the spoiler of an embodiment according to the present application, FIG. 3B is a cross-sectional view schematically illustrating the nozzle of an embodiment according to the present application;

FIG. 3C is a cross-sectional view schematically illustrating the nozzle of another embodiment according to the present application;

FIG. 4 is a three-dimensional view schematically illustrating the spoiler of an embodiment according to the present application;

FIG. 5 is a three-dimensional view schematically illustrating the spoiler of another embodiment according to the present application;

FIG. 6 is a three-dimensional view schematically illustrating the spoiler of another embodiment according to the present application;

FIG. 7 is a cross-sectional view illustrating the nozzle of another embodiment according to the present application;

FIG. 8 is a three-dimensional view schematically illustrating the spoiler of the nozzle shown in FIG. 7;

FIG. 9 is a three-dimensional view schematically illustrating the spoiler of another embodiment according to the present application; and

FIG. 10 is a three-dimensional view schematically illustrating the spoiler of another embodiment according to the present application.

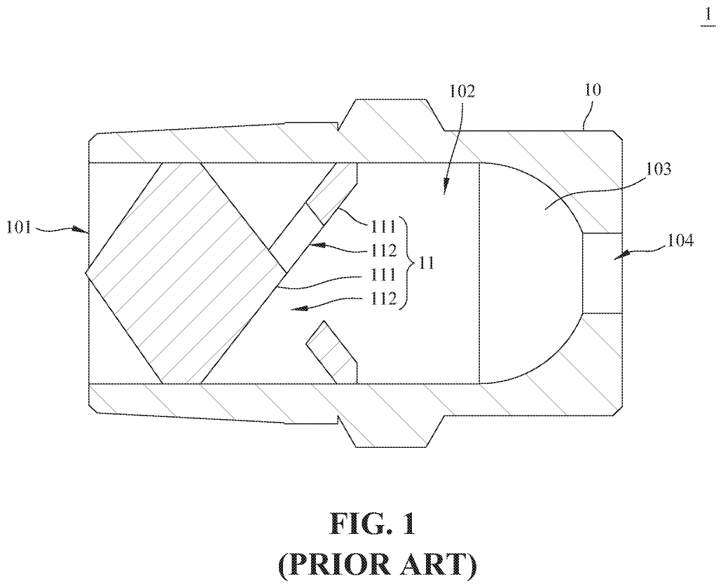

### DETAILED DESCRIPTION OF PREFERRED EMBODIMENTS

The technical features and other advantages of the present application will become more readily apparent to those ordinarily skilled in the art, by referring the following detailed description of embodiments of the present application in conjunction with the accompanying drawing. In order to further clarify the technical means adopted in the present application and the effects thereof, the figures schematically illustrate the relative relationship between the main elements, but is not based on the actual size; therefore, thickness, size, shape, arrangement and configuration of the main elements in the figure are only for reference, not intended to limit the scope of the present application.

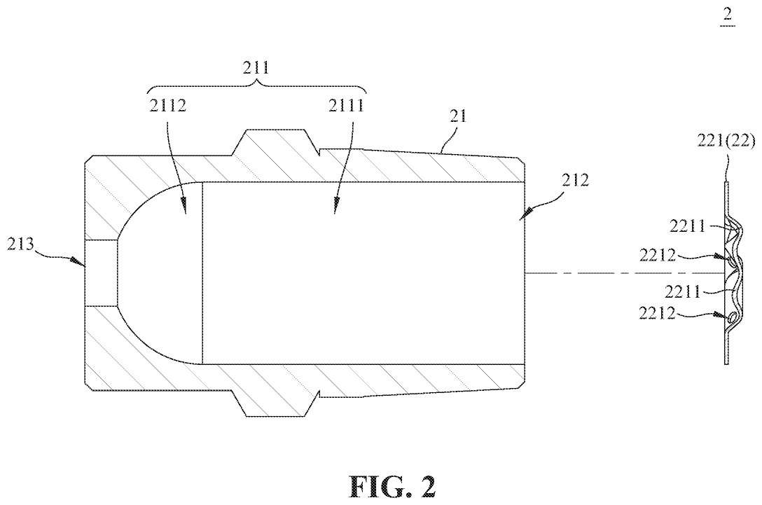

FIG. 2 is a cross-sectional exploded view schematically illustrating the nozzle of an embodiment according to the present application. As shown in FIG. 2, the nozzle 2 includes the body 21 and the spoiler 22. The body 21 has the fluid path 211, and the inlet 212 and the spray orifice 213 respectively located at opposite two sides of the fluid path 211. The spoiler 22 is detachably disposed in the fluid path 211, and includes the barrier plate 221 parallel to the inlet 212, the barrier plate 221 has a plate-like shape and the grooves 2211, a number of the grooves 2211 can be two, three, four, five or more, adjacent two of the grooves 2211 are separated by an angle (for example but not limited to: 120°, 90°, 72°), and the through hole 2212 is formed at each groove 2211. In order to split fluid, the through hole 2212 is formed at an end of each grooves 2211; further, the through hole 2212 can be formed at center of the barrier plate 221. About a diameter of the through hole 2212 and a depth of the groove 2211 (along a direction perpendicular to the barrier plate 221), the diameter of the through hole 2212 is slightly less than the depth of the groove 2211, for example, the depth of the groove 2211 is 2 mm, and the diameter of the through hole 2212 is 1.8 mm.

The fluid path 211 of the body 21 includes a turbulence region 2111 and an atomization region 2112, the turbulence region 2111 is a cylindrical space, the atomization region 2112 shrinks from the cylindrical space to a hemispherical space, the inlet 212 is located at a side of the turbulence region 2111, and the spray orifice 213 is located at center of a side of the atomization region 2112. On a section perpendicular to a flowing direction of the fluid, a cross-sectional area of the spray orifice 213 is less than a cross-sectional area of the inlet 212, and a shape of the spray orifice 213 is but not limited to a cylinder, a polygonal column, a cone or a pyramid. To take the nozzle of ¼ PT outer tooth as an example, the diameter of the inlet 212 is about 8 mm, the diameter of the spray orifice 213 is about 3.5 mm.

The vane of the conventional nozzle has a limitation on an installation direction, and the spoiler 22 according to the present application does not have the limitation on the installation direction, the spoiler 22 may be disposed in the fluid path 211 in a way that the grooves 2211 face the inlet 212 or the spray orifice 213. When the fluid (not shown) enters the turbulence region 2111 from the inlet 212 of the body 21, the barrier plate 221 blocks the flow of the fluid, the grooves 2211 guide the fluid to split into plural divided streams flowing on different directions, each divided stream that passed through the narrow through hole 2212 forms dispersed droplets, the droplets rotate and linearly move in the atomization region 2112, and the droplets passing through the spray orifice 213 are further dispersed due to the centrifugal force to form a spray of a specific shape. The shape of the spray is but not limited to hallow or full cone, a spray angle of the spray is from 50° to 120°.

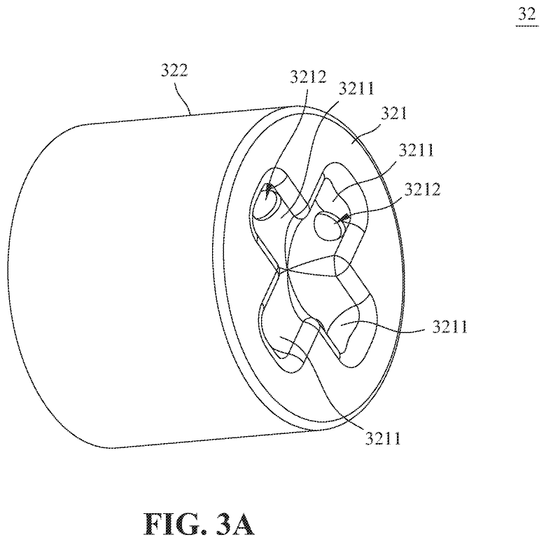

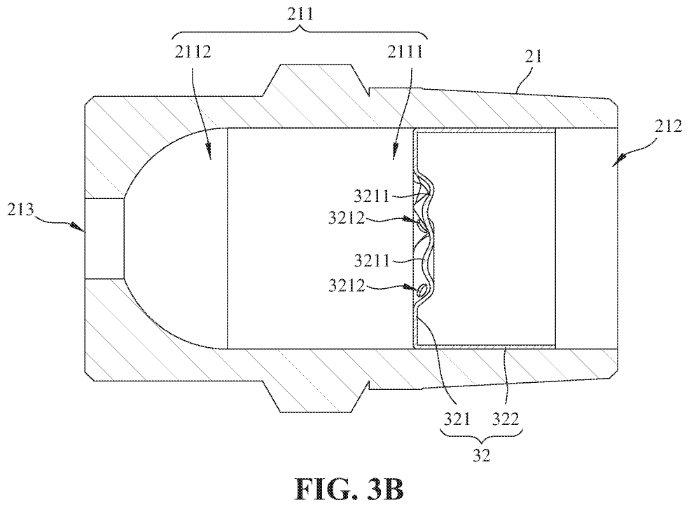

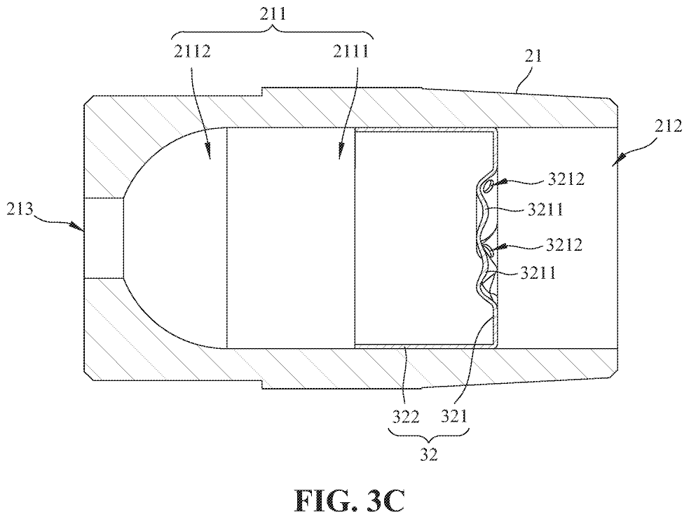

FIG. 3A is a three-dimensional view schematically illustrating the spoiler of an embodiment according to the present application. As shown in FIG. 3A, the spoiler 32 includes the barrier plate 321 and a side wall 322 connecting to the barrier plate 321, a surface profile of the side wall 322 corresponds to a shape of the fluid path 211, the surface profile thereof is but not limited to polygonal column or cylinder. In this embodiment, the barrier plate 321 has four of the grooves 3211 formed on the directions toward the side wall 322, the four grooves 3211 respectively extend on different directions from the center of the barrier plate 321 to form a cross shape, and the through hole 3212 is formed at a side of the extended end of each grooves 3211.

FIG. 3B is a cross-sectional view schematically illustrating the nozzle of an embodiment according to the present application. As shown in FIG. 3B, the spoiler 32 is disposed in the turbulence region 2111 of the fluid path 211 in a way that the grooves 3211 face the spray orifice 213 of the body 21. When the fluid (not shown) enters the turbulence region 2111 from the inlet 212 of the body 21, the barrier plate 321 blocks the flow of the fluid, a convex surface opposite the grooves 3211 guides the fluid to split into plural divided streams flowing on different directions, each divided stream flows into the groove 3211 through the narrow through hole 3212, a portion of the divided streams impact on the grooves 3211 to form dispersed droplets, a portion of the divided streams that flow along the grooves 3211 impact on the center of the barrier plate 321 to form dispersed droplets, the droplets rotate and linearly move in the atomization region 2112, and the droplets passing through the spray orifice 213 are further dispersed due to the centrifugal force to form the spray of the specific shape.

FIG. 3C is a cross-sectional view schematically illustrating the nozzle of another embodiment according to the present application. As shown in FIG. 3C, the spoiler 32 is disposed in the turbulence region 2111 of the fluid path 211 in a way that the grooves 3211 face the inlet 212 of the body 21. When the fluid (not shown) enters the turbulence region 2111 from the inlet 212 of the body 21, the barrier plate 321 blocks the flow of the fluid, the grooves 3211 guide the fluid to split into plural divided streams flowing on different directions, each divided stream that passed through the narrow through hole 3212 impact on an inner surface of the fluid path 211 to form dispersed droplets, the droplets rotate and linearly move in the atomization region 2112, and the droplets passing through the spray orifice 213 are further dispersed due to the centrifugal force to form the spray of the specific shape.

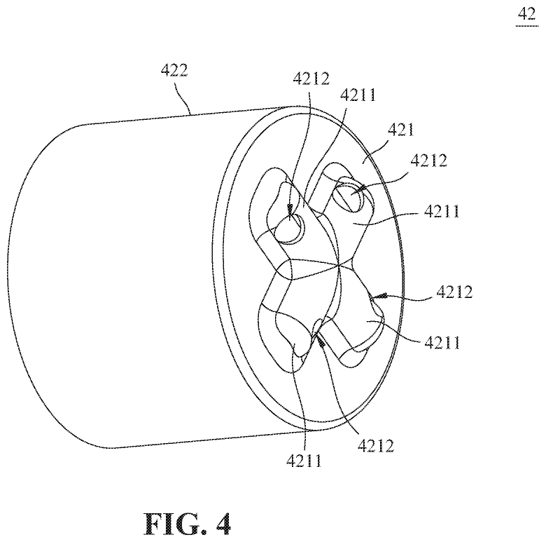

FIG. 4 is a three-dimensional view schematically illustrating the spoiler of an embodiment according to the present application. As shown in FIG. 4, in this embodiment, the body of the nozzle has the same shape and structure as shown in FIG. 2, 3B or 3C, the spoiler 42 includes the barrier plate 421 and the cylindrical side wall 422 connecting to barrier plate 421, the barrier plate 421 has four of the grooves 4211 formed on the direction opposite the side wall 422, the four grooves 4211 respectively extend on different directions from the center of the barrier plate 421 to form a cross shape, and the through hole 4212 is formed at a side of the extended end of each grooves 4211.

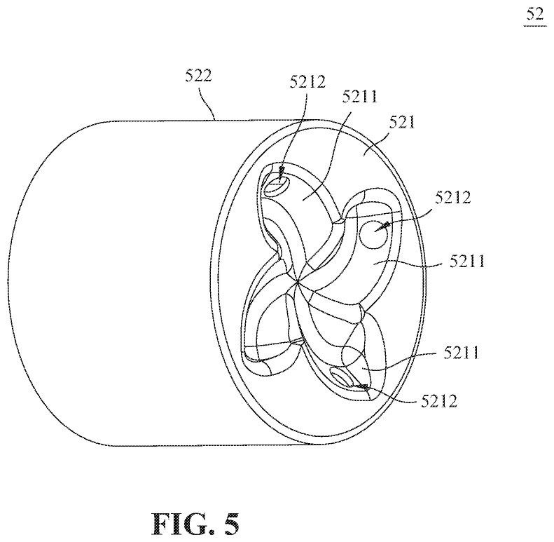

FIG. 5 is a three-dimensional view schematically illustrating the spoiler of another embodiment according to the present application. As shown in FIG. 5, in this embodiment, the body of the nozzle has the same shape and structure as shown in FIG. 2, 3B or 3C, the spoiler 52 includes the barrier plate 521 and the cylindrical side wall 522 connecting to the barrier plate 521, the barrier plate 521 has four of the grooves 5211 formed on the direction toward the side wall 522, the four grooves 5211 respectively extend on different directions from the center of the barrier plate 521 to form a spiral shape, and the through hole 5212 is formed at a side of the extended end of each grooves 5211.

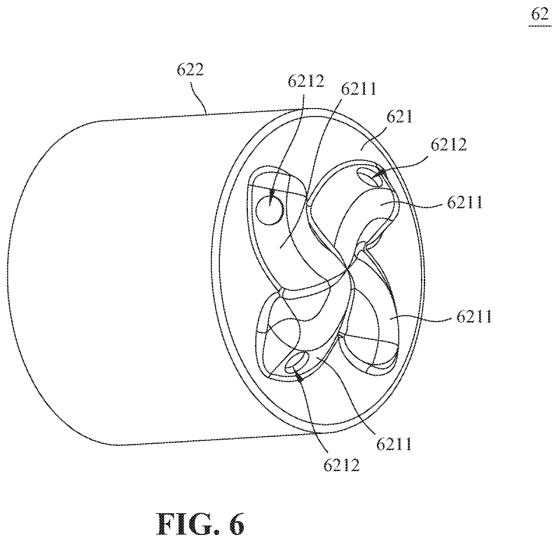

FIG. 6 is a three-dimensional view schematically illustrating the spoiler of another embodiment according to the present application. As shown in FIG. 6, in this embodiment, the body of the nozzle has the same shape and structure as shown in FIG. 2, 3B or 3C, the spoiler 62 includes the barrier plate 621 and the cylindrical side wall 6212 connecting to the barrier plate 621, the barrier plate 621 has four of the grooves 6211 formed on the direction opposite the side wall 622, the four grooves 6211 respectively extend on different directions from the center of the barrier plate 621 to form a spiral shape, and the through hole 6212 is formed at a side of the extended end of each grooves 6211.

The spoiler 42, 52, 62 (shown in FIGS. 4, 5 and 6) can be disposed in the turbulence region 2111 of the fluid path 211 in a way that the grooves 4211, 5211, 6211 face the inlet 212 or spray orifice 213 of the body 21. When the fluid (not shown) enters the turbulence region 2111 from the inlet 212 of the body 21, the grooves 4211, 5211, 6211 or the convex surface opposite the grooves 4211, 5211, 6211 guide the fluid to split into plural divided streams flowing on different directions, each divided stream is dispersed to form droplets due to repeated impact, the droplets rotate and linearly move in the atomization region 2112, and the droplets passing through the spray orifice 213 are further dispersed due to the centrifugal force to form the spray of the specific shape.

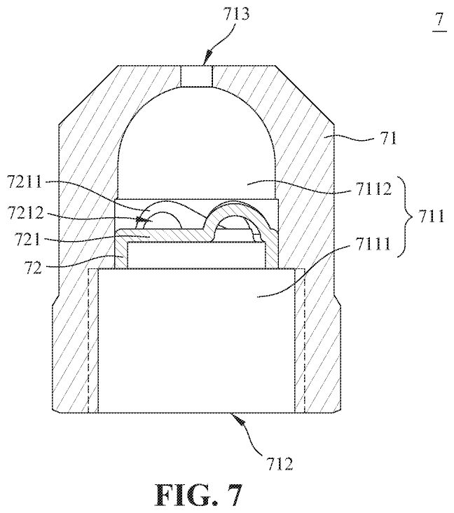

FIG. 7 is a cross-sectional view illustrating the nozzle of another embodiment according to the present application. As shown in FIG. 7, the nozzle 7 includes the body 71 and the spoiler 72. The body 71 has the fluid path 711, and the inlet 712 and the spray orifice 713 respectively located at opposite two sides of the fluid path 711. The fluid path 71 includes the turbulence region 7111 and the atomization region 7112. The spoiler 72 includes the barrier plate 721 parallel to the inlet 712, and the side wall 722 connecting to the barrier plate 721. The barrier plate 721 has the grooves 7211, the number of the grooves 7211 can be two, three, four, five or more, and the through hole 7212 is formed at each groove 7211. An outer diameter of the side wall 722 corresponds to an inner diameter of the atomization 7112, and the spoiler 72 is detachably disposed in the atomization region 7112 close to the side thereof connecting to turbulence region 7111.

The turbulence region 7111 is a cylindrical space, the atomization region 7112 shrinks from the cylindrical space to a hemispherical space, the inlet 712 is located at a side of the turbulence region 7111, and the spray orifice 713 is located at center of a side of the atomization region 7112. On a radial cross section of the fluid path 711, an inner diameter of the turbulence region 713 is greater than an outer diameter of the atomization region 7112.

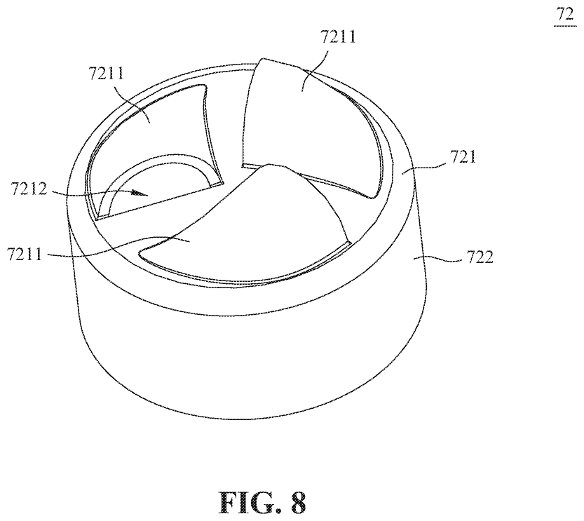

FIG. 8 is a three-dimensional view schematically illustrating the spoiler of the nozzle shown in FIG. 7. As shown in FIG. 8, the spoiler 72 includes the barrier plate 721 and the cylindrical side wall 722 connecting to the barrier plate 721, three of the grooves 7211 are annularly arranged and do not connect to each other, each groove 7211 has a cone-like shape, a depth and a width of each groove 7211 increases from one end to the other end, and the through hole 7212 is formed at the end having the greatest width of each groove 7211.

When the fluid (not shown) enters the turbulence region 7111 from the inlet 712 of the body 71, the barrier plate 721 blocks the flow of the fluid, the grooves 7211 guide the fluid to split into three vortexes flowing on different directions, each vortex that passed through the through hole 7212 impacts on the convex surface opposite the groove 7211 and the inner surface of the atomization region 7112 to form dispersed droplets, the droplets rotate and linearly move in the atomization region 7112, and the droplets passing through the spray orifice 713 are further dispersed due to the centrifugal force to form the spray of the specific shape. The shape of the spray is but not limited to hallow or full cone, the spray angle of the spray is from 50° to 120°.

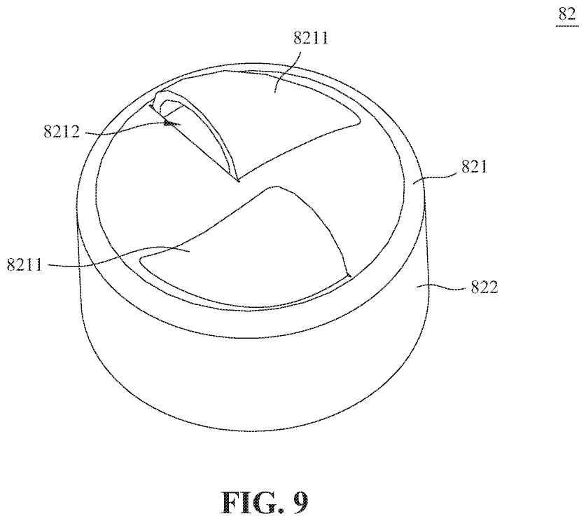

FIG. 9 is a three-dimensional view schematically illustrating the spoiler of another embodiment according to the present application. As shown in FIG. 9, in this embodiment, the nozzle has the same shape and structure as shown in FIG. 7, the spoiler 82 includes the barrier plate 821 and the cylindrical side wall 822 connecting to the barrier plate 821, two of the grooves 8211 are staggered and do not connect to each other, each groove 8211 has a cone-like shape, a depth and a width of each groove 8211 increase from one end to the other end, the through hole 8212 is formed at the end having the greatest width of each groove 8211.

When the fluid (not shown) enters the turbulence region 7111 from the inlet 712 of the body 71, the barrier plate 821 blocks the flow of the fluid, the grooves 8211 guide the fluid to split into two vortexes flowing on different directions, each vortex that passed through the through hole 8212 impacts on the convex surface opposite the groove 8211 and the inner surface of the atomization region 7112 to form dispersed droplets, the droplets rotate and linearly move in the atomization region 7112, and the droplets passing through the spray orifice 713 are further dispersed due to the centrifugal force to form the spray of the specific shape. The shape of the spray is but not limited to hallow or full cone, the spray angle of the spray is from 50° to 120°.

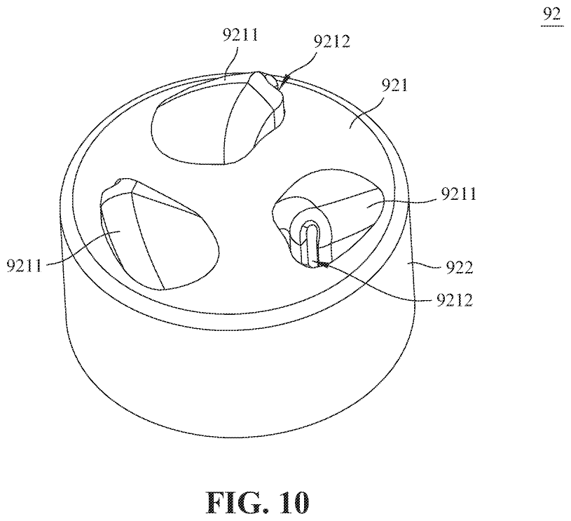

FIG. 10 is a three-dimensional view schematically illustrating the spoiler of another embodiment according to the present application. As shown in FIG. 10, the nozzle has the same shape and structure as shown in FIG. 7, the spoiler 92 includes the barrier plate 921 and the cylindrical side wall 922 connecting to the barrier plate 921, three of the grooves 9211 are annularly arranged and do not connect to each other, each groove 9211 has a fan-like shape, a depth and a width of each groove 9211 increases from one end to the other end, and the through hole 9212 is formed at the end having the least width of each groove 9211.

When the fluid (not shown) enters the turbulence region 7111 from the inlet 712 of the body 71, the barrier plate 921 blocks the flow of the fluid, the grooves 9211 guide the fluid to split into three vortexes flowing on different directions, each vortex that passed through the through hole 9212 impacts on the convex surface opposite the groove 9211 and the inner surface of the atomization region 7112 to form dispersed droplets, the droplets rotate and linearly move in the atomization region 7112, and the droplets passing through the spray orifice 713 are further dispersed due to the centrifugal force to form the spray of the specific shape. The shape of the spray is but not limited to hallow or full cone, the spray angle of the spray is from 50° to 120°.

In the nozzle according to the present application, the spoiler disposed in the body includes the barrier plate, the barrier plate has grooves, the through hole is formed at each groove, the fluid in the fluid path split by the grooves and the through holes, then impact to form uniformly dispersed droplets, so that a spray having a specific shape and effect is produced. It is worthy to note that the spoiler according to the present application can be manufactured through a stamping process, a number of the spoiler that can be produced per minute is up to one thousand with a current stamping equipment, and the spoiler has high precision and no limitation on the direction disposed in the body; accordingly, the manufacturing cost of the nozzle is reduced, the manufacturing process of the nozzle does not produce the air pollution, dimensional accuracy and combined density of the body and the spoiler are also improved, and design flexibility and yield of the nozzle are increased, so that the main aspect of the present application is achieved.

The exemplary embodiments described above only illustrate the principles and effects of the present application, but are not intended to limit the scope of the present application. Based on the above description, an ordinarily skilled in the art can complete various similar modifications and arrangements according to the technical programs and ideas of the present application, and the scope of the appended claims of the present application should encompass all such modifications and arrangements.

What is claimed is:

1. A nozzle, comprising:
a body, having a fluid path, and an inlet and a spray orifice respectively located at opposite two sides of the fluid path; and
a spoiler, detachably disposed in the fluid path, comprising a barrier plate parallel to the inlet, wherein the barrier plate has grooves, and each groove has a through hole.

2. The nozzle according to claim 1, wherein the spoiler comprises a side wall connecting to the barrier plate.

3. The nozzle according to claim 2, wherein a surface profile of the side wall corresponds to a shape of the fluid path.

4. The nozzle according to claim 1, wherein the spoiler is disposed in the fluid path in a way that the grooves face the inlet.

5. The nozzle according to claim 1, wherein the spoiler is disposed in the fluid path in a way that the grooves face the spray orifice.

6. The nozzle according to claim 1, wherein the grooves respectively extend from a center of the barrier plate on different directions, and the grooves are separated from each other by an angle.

7. The nozzle according to claim 6, wherein the through hole is formed at a side of an extended end of each groove.

8. The nozzle according to claim 6, wherein the through hole is formed at the center of the barrier plate.

9. The nozzle according to claim 1, wherein the grooves are not connected to each other.

10. The nozzle according claim 1, wherein a width of each groove gradually increases from one end to the other end, and the through hole is formed at the end of the largest or smallest width of the groove.
